(19) United States
(12) Patent Application Publication
(10) Pub. No.: US 2023/0370556 A1
(43) Pub. Date: Nov. 16, 2023

(54) RECORDING MATERIAL DETERMINATION DEVICE, RECORDING MATERIAL DETERMINATION METHOD, RECORDING MEDIUM, AND IMAGE FORMING APPARATUS

(71) Applicant: KONICA MINOLTA, INC., Tokyo (JP)

(72) Inventors: Yumiko IZUMIYA, Tokyo (JP); Hitoshi ASANO, Toyokawa-shi (JP); Yasuhiro KOIDE, Toyohashi-shi (JP); Hiroyuki YOSHIKAWA, Toyohashi-shi (JP)

(73) Assignee: KONICA MINOLTA, INC., Tokyo (JP)

(21) Appl. No.: 18/196,582

(22) Filed: May 12, 2023

(30) Foreign Application Priority Data
May 12, 2022 (JP) 2022-078514

(51) Int. Cl. H04N 1/00

(52) U.S. Cl. CPC H04N 1/00652; H04N 1/00408

(57) ABSTRACT

A recording material determination device, includes: a conveyor that conveys recording materials along a conveyance path; a detector that is provided at a middle of the conveyance path, and detects a characteristic value of each of the recording materials in conveyance; and a hardware processor that controls driving of the conveyor, stops a first recording material among the recording materials at the detector, and does not stop a second recording material that is conveyed after the first recording material, wherein the hardware processor determines whether the second recording material changes with respect to the first recording material, based on a first characteristics detection result of the first recording material detected by the detector, and on a second characteristics detection result of the second recording material detected by the detector.

### CROSS-REFERENCE TO RELATED APPLICATIONS

The entire disclosure of Japanese Patent Application No. 2022-078514 filed on May 12, 2022 is incorporated herein by reference in its entirety.

### TECHNICAL FIELD

The present invention relates to a recording material determination device, a recording material determination method, a recording medium, and an image forming apparatus.

### DESCRIPTION OF THE RELATED ART

Conventionally, in an image forming apparatus, such as a copier, a printer or a multifunction machine, information pertaining to a recording material stored in a sheet feeder tray is preliminarily registered in a controller, and timing of conveying the recording material and timing of forming an image on the recording material are determined based on information preliminarily registered in the controller. Accordingly, if information on the recording material preliminarily registered in the controller is inconsistent with an actual recording material to be sent from the sheet feeder tray, the image forming apparatus causes a deviation in timing of conveying the recording material, and a deviation in timing of forming an image on the recording material. The deviation in timing of conveying the recording material in the image forming apparatus causes a failure, such as recording material jamming, or deformation of the recording material. The deviation in timing of forming an image on the recording material causes a failure of degradation of image quality.

Accordingly, the conventionally known image forming apparatus is provided with a medium sensor (detection unit) at a middle of a conveyance path for a recording material, detects, by the medium sensor, a characteristic value of the recording material conveyed along the conveyance path, and discriminates the type, basis weight or brand of the recording material, using the characteristic value of the recording material. The conventional image forming apparatus compares a discrimination result of the recording material with the recording material information preliminarily registered in the controller. If the discrimination result of the recording material does not coincide with the recording material registration information, the apparatus warns a user through a display (e.g., a liquid crystal display panel), and avoids occurrence of a failure caused by inconsistency between information on the recording material preliminarily registered in the controller and the actual recording material sent from the sheet feeder tray. The conventional image forming apparatus detects the types of all recording materials sent from the sheet feeder tray to the conveyance path in consideration of the fact that various types of recording materials are mixedly mounted in the sheet feeder tray. With reference to the type of the first recording material, this apparatus determines whether or not the subsequent recording material changes (see JP 2015-160737A).

### SUMMARY OF THE INVENTION

However, when the conventional image forming apparatus stops, at the detector, every recording material sent from the sheet feeder tray to the conveyance path, and detects the characteristic value of the recording material by the medium sensor provided in the detector, this apparatus can accurately detect the characteristic value of the recording material. Since the recording material is stopped at the detector on a one-by-one basis, a problem occurs that the productivity in image formation (print rate (sheets/min.)) is reduced.

In a case where the conventional image forming apparatus does not stop, at the detector, a recording material sent from the sheet feeder tray to the conveyance path, and detects the characteristic value of the recording material moving along the conveyance path by the medium sensor provided in the detector, the attitude of the recording material changes (a deviation occurs from a reference attitude of the recording material) depending on a conveyance state, and the detection position of the recording material sometimes deviates from a reference detection position of the detector. If a detection error occurs in a detection value of the first recording material, such a conventional image forming apparatus determines coincidence or noncoincidence with a subsequent recording material with reference with the detection value including this detection error. Accordingly, a problem occurs that the accuracy of determination of coincidence or noncoincidence of the recording material is degraded.

The present invention has an object to provide a recording material determination device, a recording material determination method, a recording medium for the recording material determination device, and an image forming apparatus that can accurately determine coincidence or noncoincidence of the recording material without causing reduction in productivity in image formation.

To achieve at least one of the abovementioned objects, according to an aspect of the present invention, a recording material determination device reflecting one aspect of the present invention includes:

a conveyor that conveys recording materials along a conveyance path;

a detector that is provided at a middle of the conveyance path, and detects a characteristic value of each of the recording materials in conveyance; and

a hardware processor that controls driving of the conveyor, stops a first recording material among the recording materials at the detector, and does not stop a second recording material that is conveyed after the first recording material,

wherein the hardware processor determines whether the second recording material changes with respect to the first recording material, based on a first characteristics detection result of the first recording material detected by the detector, and on a second characteristics detection result of the second recording material detected by the detector.

To achieve at least one of the abovementioned objects, according to an aspect of the present invention, a recording material determination method reflecting one aspect of the present invention includes:

conveying recording materials along a conveyance path;

detecting a characteristic value of each of the recording materials in conveyance, by a detector provided at a middle of the conveyance path; and

controlling driving of the conveyor, stopping a first recording material among the recording materials at the detector, and not stopping a second recording material that is conveyed after the first recording material,

wherein the controlling determines whether the second recording material changes with respect to the first recording material, based on a first characteristics detection result of the first recording material detected by the detector, and on a second characteristics detection result of the second recording material detected by the detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a configuration diagram of an image forming apparatus that includes a recording material determination device according to a first embodiment of the present invention;

FIG. 2 shows part of the recording material determination device in FIG. 1 in an enlarged manner;

FIG. 3 is a functional block diagram showing a control structure of an image forming apparatus that includes a recording material determination device;

FIG. 4 is a flowchart showing an operation state of the recording material determination device;

FIG. 5 shows a case where the characteristic value of a first recording material stopped at a detector is detected, and a case where the characteristic value is detected while the first recording material is not stopped at the detector, in a compared manner;

FIG. 6 shows discrimination of a type of a recording material based on a discrimination algorithm;

FIG. 7 is a diagram for illustrating a determination threshold in a controller;

FIG. 8 is a flowchart showing an operation state of the recording material determination device according to Modification 1;

FIG. 9 is a flowchart showing an operation state of the recording material determination device according to Modification 2; and

FIG. 10 is a configuration diagram of an image forming apparatus that includes a recording material determination device according to a second embodiment of the present invention.

### DETAILED DESCRIPTION

Hereinafter, one or more embodiments of the present invention will be described with reference to the drawings. However, the scope of the invention is not limited to the disclosed embodiments.

### First Embodiment

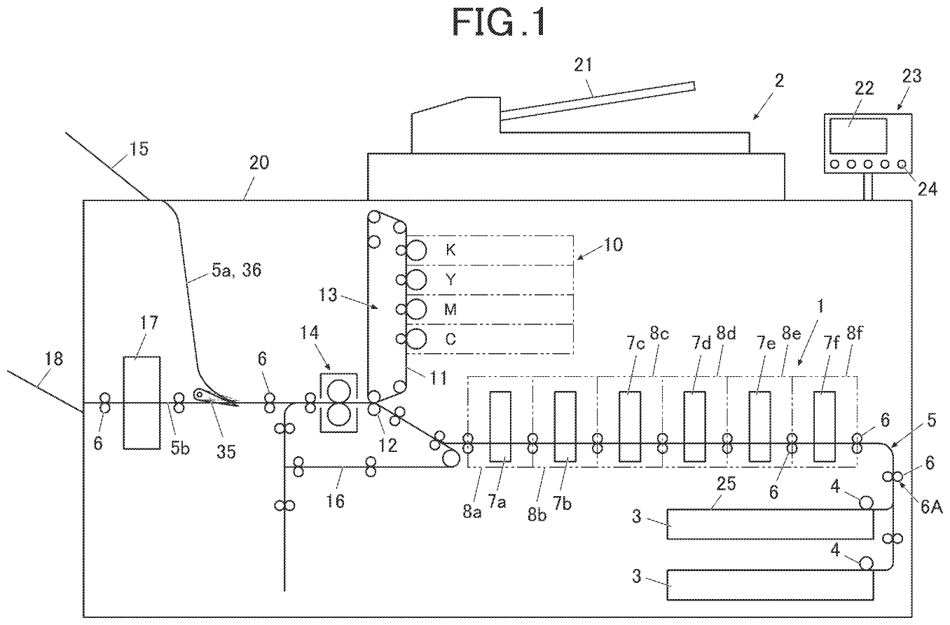

FIG. 1 is a configuration diagram of an image forming apparatus 2 that includes a recording material determination device 1 according to a first embodiment of the present invention.

As shown in FIG. 1, according to the image forming apparatus 2, sheet-shaped recording materials 25 stacked on each sheet feeder tray (sheet feeder) 3 are sent one by one to a conveyance path 5 by a sheet feeder roller 4. The recording material 25 sent to the conveyance path 5 is conveyed along the conveyance path 5 by a conveyor 6A that includes a plurality of conveyance roller pairs 6. At the middle of the conveyance path 5 there are provided detectors 8a, 8b, 8c, 8d, 8e, 8f (as many as detection units 7a, 7b, 7c, 7d, 7e, 7f) that respectively cause detection units 7a, 7b, 7c, 7d, 7e, 7f to detect characteristic values (a basis weight, a paper thickness, etc.) of the recording material 25. On a downstream side of a conveyance direction of the recording material 25 with respect to the detectors 8a, 8b, 8c, 8d, 8e, 8f, an image former 10 that forms C (cyan), M (magenta), Y(yellow) and K(black) toner images, an intermediate transfer belt 11 onto which the toner images formed by the image former 10 are transferred, and a secondary transfer roller 12 that secondarily transfers the toner images transferred on the intermediate transfer belt 11 onto the recording material 25 are arranged. Note that the intermediate transfer belt 11 and the secondary transfer roller 12 constitute a transferrer 13 that transfers the toner image onto the recording material 25.

The recording material 25 on which the toner image is transferred is sent into the fixer 14, and heated and pressurized by the fixer 14, thereby allowing the toner image to be fixed. In a case of a print job in a single-sided printing mode, the recording material 25 having passed through the fixer 14 is conveyed by the conveyance roller pairs 6 along the conveyance path 5 (5a), and sequentially ejected onto a sheet ejection tray 15. In a case of a print job in a double-sided printing mode, the recording material 25 having passed through the fixer 14 is conveyed to a conveyance path 16 for double-sided printing, the two sides are reversed, this material is sequentially conveyed to the transferrer 13 and the fixer 14, and subsequently is ejected on the sheet ejection tray 15 by the conveyance roller pairs 6. In a case of applying a post-process, such as a staple process, to the recording material 25 having passed through the fixer 14, the conveyance path 5 (5b) for the recording material 25 is switched, the fixing-processed recording material 25 is sent to a post-processing apparatus 17, and the post-processed recording material 25 is ejected onto a sheet ejection tray (sheet ejector) 18.

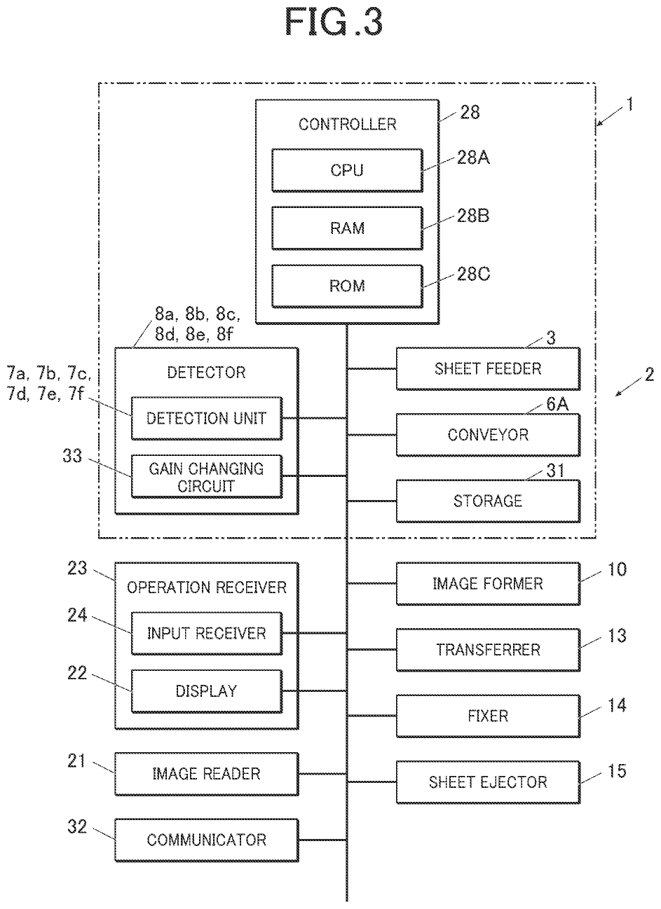

As shown in FIG. 1, as for the image forming apparatus 2, at an upper part of an image forming apparatus main body 20 there are provided a document reading device (image reader) 21, and an operation receiver 23 that includes a display 22 (e.g., a liquid crystal display panel). The operation receiver 23 includes: a numeric keypad (input receiver) 24 for presetting various types of data in a RAM 28B of a controller 28 (hardware processor) or a storage 31; and a liquid crystal display panel (display 22) that allows character input and can display various types of data (see FIG. 3). Note that the operation receiver 23 is not limited to that provided in the image forming apparatus main body 20, and may be an external PC or external information terminal apparatus connected via a communicator 32 (see FIG. 3).

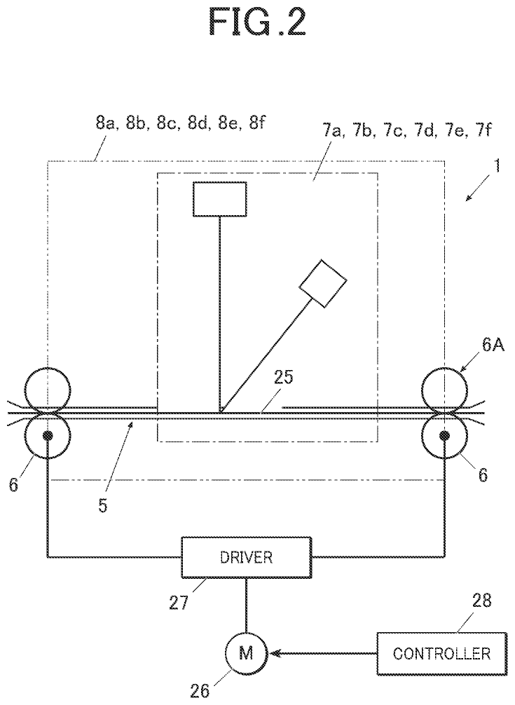

FIG. 2 shows part of the recording material determination device 1 in FIG. 1 in an enlarged manner. As shown in FIGS. 1 and 2, the recording material determination device 1 includes: the plurality of conveyance roller pairs 6 that conveys the recording material 25 having sent from a sheet feeder tray 3, along the conveyance path 5; and a driver (gears, belts, etc.) 27 that transfers the rotation of a motor 26 to the multiple conveyance roller pairs 6. As shown in FIG. 2, the motor 26 is subjected to drive control by the controller 28. The characteristic values of the recording material 25 conveyed to the detector 8a (8b, 8c, 8d, 8e, 8f) by the multiple conveyance roller pairs 6 are detected by the detection units 7a (7b, 7c, 7d, 7e, 7f) arranged in the detector 8a (8b, 8c, 8d, 8e, 8f).

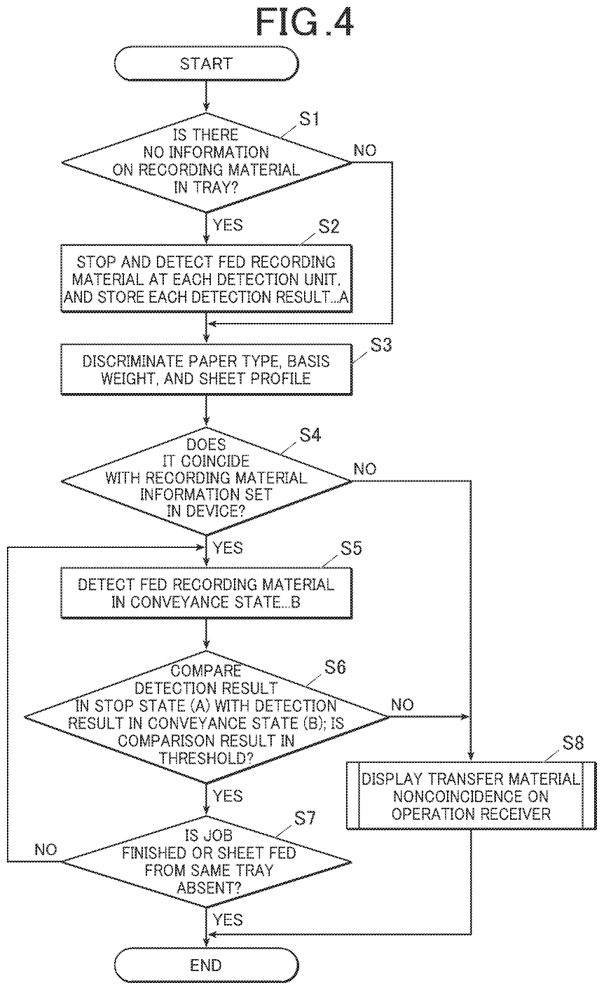

FIG. 3 is a functional block diagram showing a control structure of the image forming apparatus 2 that includes the recording material determination device 1. FIG. 4 is a flowchart showing an operation state of the recording material determination device 1.

As shown in FIG. 3, the controller 28 is, for example, a computer including a CPU 28A, the RAM 28B, a ROM 28C and the like. In this embodiment, according to an operation signal input through the operation receiver 23 or an instruction signal received through the communicator 32, the CPU 28A reads various processing programs stored in the ROM 28C, loads the programs into a work area of the RAM 28B, and integrally controls the operation of the image forming apparatus 2 through cooperation with the various processing programs loaded in the RAM 28B.

For description of the flowchart of FIG. 4, a recording material 25 sent to the conveyance path 5 from the sheet feeder tray 3 first is assumed as a first recording material 25, and a recording material 25 sent to the conveyance path 5 from the sheet feeder tray 3 after the first recording material 25 is assumed as a second recording material 25. First, after start of a print job, in the recording material determination device 1 according to this embodiment, if the controller 28 determines that there is no information on the recording material in the sheet feeder tray 3 about the first recording material 25 (step S1: YES), the controller 28 conveys the first recording material 25 to each of the detectors 8a, 8b, 8c, 8d, 8e, 8f arranged at the middle of the conveyance path 5, and stops the first recording material 25 at each of the detectors 8a, 8b, 8c, 8d, 8e, 8f. The controller 28 applies operation control to the conveyance roller pairs 6 so as to stop the first recording material 25 until the characteristic values of the first recording material 25 (at least the surface property, rigidity, resistance, moisture rate, basis weight and paper thickness) are detected by the detection units 7a, 7b, 7c, 7d, 7e, 7f in the detectors 8a, 8b, 8c, 8d, 8e, 8f. The controller 28 causes the detection units 7a, 7b, 7c, 7d, 7e, 7f to detect the characteristic values of the first recording material 25 at the respective detectors 8a, 8b, 8c, 8d, 8e, 8f. Note that the information on the recording material in the sheet feeder tray 3 is data on the recording material 25 detected by a detection unit, not shown, provided in the sheet feeder tray 3 (any of various sheet information detection sensors, such as a size detection sensor, for example), and sheet information input into the RAM 28B or the storage 31 through the operation receiver 23, corresponds to first characteristics detection result described later, and is recorded in the RAM 28B or the storage 31 in a readable manner. Note that the storage 31 includes storages, such as an HDD (hard disk drive) and an SSD (solid state drive), and stores various programs and various setting data items in a readable and writable manner.

As shown in FIGS. 1 to 3, the detection units 7a, 7b, 7c, 7d, 7e, 7f are provided in the respective detectors 8a, 8b, 8c, 8d, 8e, 8f provided along the conveyance path 5, and are made up of sensors for detecting the characteristic values of the recording material 25 (at least any of the surface property, rigidity, resistance, moisture rate, basis weight, and paper thickness). That is, the detection units 7a, 7b, 7c, 7d, 7e, 7f include multiple types of sensors that are an optical sensor that detects the surface property (e.g., the roughness, and gloss) of the recording material 25, a mechanical rigidity detection sensor that detects the rigidity (e.g., the bending strength) of the recording material 25, a resistive sensor that detects the resistance value of the recording material 25, a moisture detection sensor that detects the moisture rate of the recording material 25 using near infrared light, a basis weight detection sensor that detects the basis weight of the recording material 25 (e.g., an optical sensor that measures the basis weight, based on light with which the recording material 25 has been irradiated and which has transmitted through this material, and reflected light), and a paper thickness detection sensor that detects the paper thickness (a rotary encoder or the like that detects the paper thickness, based on the displacement between the conveyance roller pairs 6). The characteristic values of the first recording material 25 detected by the detection units 7a, 7b, 7c, 7d, 7e, 7f of the detectors 8a, 8b, 8c, 8d, 8e, 8f are stored as a first characteristics detection result in the RAM 28B or the storage 31 in a readable manner (step S2). Note that an exemplary mode is described where in the recording material determination device 1 in this embodiment, the detectors 8a, 8b, 8c, 8d, 8e, 8f are provided at six positions along the conveyance path 5, and the detection units 7a, 7b, 7c, 7d, 7e, 7f that are different from each other are provided in the respective detectors 8a, 8b, 8c, 8d, 8e, 8f. However, there is no limitation to this. Detectors and detection units, the numbers of which are sufficient to support the characteristic values of the recording material 25 to be detected, are provided. FIG. 1 shows the configuration that detects one type of characteristic value by each of the detectors 8a, 8b, 8c, 8d, 8e, 8f. A configuration may be adopted where one detector detects multiple types of characteristic values.

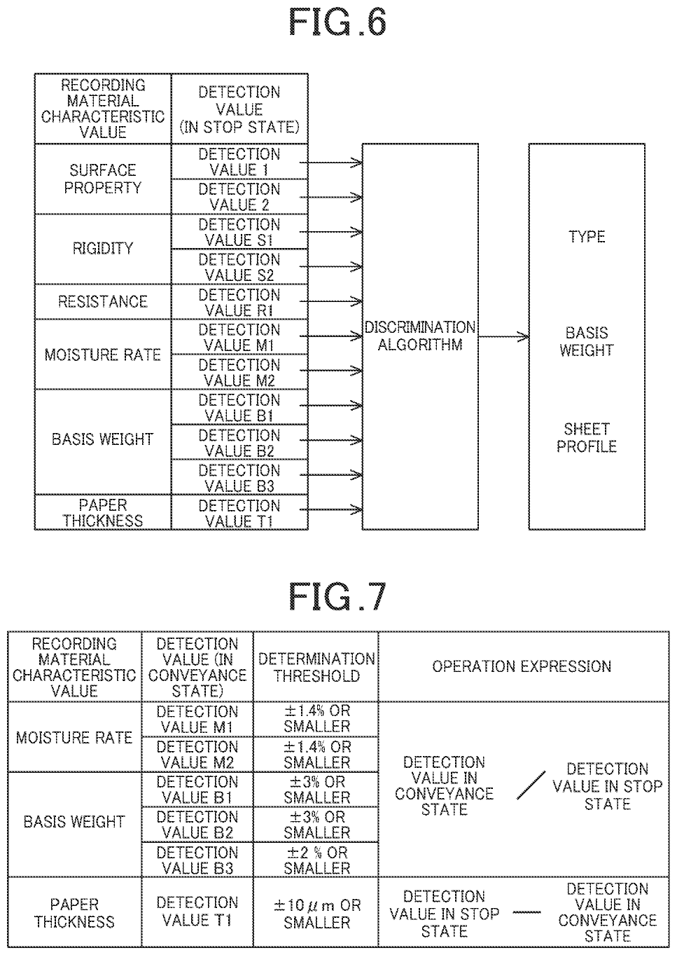

Next, as shown in FIGS. 3, 4 and 6, the controller 28 of the recording material determination device 1 executes type discrimination of the recording material 25, based on a preset discrimination algorithm, using the first characteristics detection result stored in the RAM 28B or the storage 31 (detection values corresponding to the respective recording material characteristic values; at least the surface property, rigidity, resistance, moisture rate, basis weight, and paper thickness) (step S3). At least any of the type, the basis weight and the sheet profile is obtained as a result of the type discrimination.

Next, as shown in FIGS. 3 and 4, the controller 28 determines whether the result of type discrimination (at least any of the type, the basis weight and the sheet profile) coincides with the sheet information on the recording material 25 preliminarily registered in the RAM 28B or the storage 31 (any of at least the type, the basis weight and the sheet profile corresponding to the result of the type discrimination, as the recording material information) or not (step S4). Note that the RAM 28B or the storage 31 stores the information on the recording material 25 (the type, basis weight, brand, sheet profile, etc.) set by the user (input through the operation receiver 23). The sheet information on the recording material 25 stored in the RAM 28B or the storage 31 is used when it is determined which one among the provided sheet feeder trays 3 is used, and is used when timing of forming an image on the recording material 25 and the like are determined.

The controller 28 may omit step S3 (discrimination of the paper type, the basis weight, and the sheet profile) by determining whether the first characteristics detection result (at least any of the surface property, the rigidity and the resistance) stored in the RAM 28B or the storage 31 coincides with the information on the recording material 25 (at least any of the surface property, the rigidity, and the resistance) preset by the user, and discriminate whether the information on the recording material 25 set in the recording material determination device 1 coincides with the first characteristics detection result (step S4).

Next, as shown in FIGS. 3 and 4, if the controller 28 determines that the information on the recording material (the sheet information registered in the RAM 28B or the storage 31) set in the recording material determination device 1 coincides with the result of the type discrimination (or the first characteristics detection result) (step S4: YES), the controller 28 applies operation control to the conveyance roller pairs 6 (conveyor 6A) so as to allow the second recording material 25 to be conveyed with no stop at the detectors 8a, 8b, 8c, 8d, 8e, 8f (step S5). Thus, the characteristic values (at least any of the basis weight, the paper thickness, and the moisture rate) of the second recording material 25 are detected in a conveyance state by the detection units 7a, 7b, 7c, 7d, 7e, 7f provided in the detectors 8a, 8b, 8c, 8d, 8e, 8f (step S5). The characteristic values of the second recording material 25 conveyed without being stopped at each of the detectors 8a, 8b, 8c, 8d, 8e, 8f are stored as the second characteristics detection result in the RAM 28B or the storage 31 in a readable manner.

Next, as shown in FIGS. 3 and 4, the controller 28 compares the first characteristics detection result with the second characteristics detection result, determines whether the difference between both the items is within a determination threshold or not, and if the difference between both the items is within the determination threshold (step S6: YES), the controller 28 determines that the first recording material 25 and the second recording material 25 are the same (the first recording material 25 and the second recording material 25 do not change), and the processing transitions to step S7. Note that in FIG. 4, the result (A) detected in the stop state corresponds to at least any of the moisture rate, the basis weight and the paper thickness of the first characteristics detection result, and the result (B) detected in the conveyance state corresponds to at least any of the moisture rate, the basis weight and the paper thickness of the second characteristics detection result.

FIG. 7 is a diagram for illustrating the determination threshold in the controller 28. The determination thresholds for the moisture rate and the basis weight shown in FIG. 7 are calculated based on the ratio between the detection value detected in a conveyance state of the recording material 25 (second characteristics detection result) and the detection value detected in a stop state of the recording material 25 (first characteristics detection result). The determination threshold for the paper thickness shown in FIG. 7 is calculated as the difference between the detection value detected in the stop state of the recording material 25 (first characteristics detection result) and the detection value detected in the conveyance state of the recording material 25 (second characteristics detection result).

Next, as shown in FIGS. 3 and 4, if the controller 28 determines that the print job is not finished or any fed sheet from the same sheet feeder tray 3 is not absent (step S7: NO) in step S7, the controller 28 detects the characteristic values of the second recording material 25 (step S5), and continues comparison between the first characteristics detection result and the second characteristics detection result (steps S6 to S7). Meanwhile, as shown in FIG. 4, if the print job is finished or the recording material detection sensor that is provided in the sheet feeder tray 3 but not shown detects that sheet feeding of the recording material 25 from the same sheet feeder tray 3 is absent and a detection signal from the recording material detection sensor is input (step S7: YES), the controller 28 stops the operation of the sheet feeder roller 4, and stops this processing.

In FIGS. 3 and 4, if the controller 28 determines that the recording material information in the sheet feeder tray 3 is not absent in step S1 (step S1: NO), the controller 28 executes type discrimination of the recording material in the sheet feeder tray 3, thus discriminating at least any of the type, the basis weight and the sheet profile of the recording material 25 (step S3).

As shown in FIGS. 3 and 4, if the controller 28 determines that the result of the type discrimination in step S3 or the first characteristics detection result does not coincide with the information on the recording material set in the recording material determination device 1 (step S4: NO), the controller 28 displays noncoincidence of the first recording material 25 (transfer material) with the information on the recording material set in the recording material determination device 1, on the display 22 of the operation receiver 23, and/or issues a notification about the noncoincidence through a speaker, not shown, thus notifying the operator visually and/or audibly (step S8).

As shown in FIGS. 3 and 4, if the controller 28 determines that the first characteristics detection result and the second characteristics detection result do not coincide with each other (step S6: NO), the controller 28 displays noncoincidence between the first recording material 25 (transfer material) and the second recording material 25 (transfer material) on the display 22 of the operation receiver 23, and/or issues a notification about the noncoincidence through the speaker, not shown, thus notifying the operator visually and/or audibly (step S8).

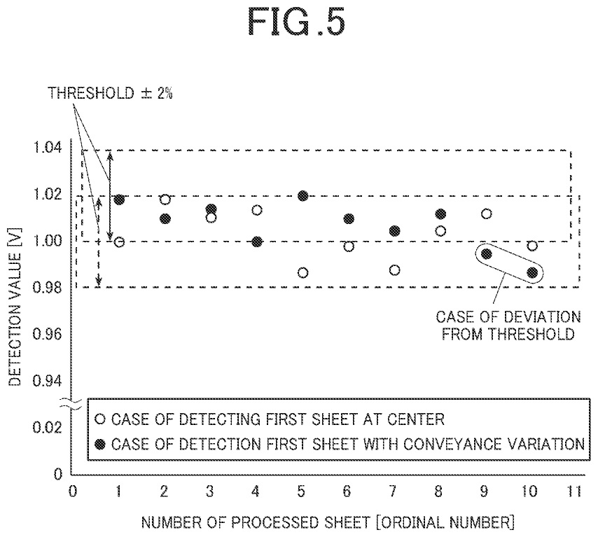

FIG. 5 shows a comparison between a case of detecting the characteristic value in a state where the first recording material 25 is stopped at each of the detectors 8a, 8b, 8c, 8d, 8e, 8f (a case without conveyance variation), and a case of detecting the characteristic value in a state where the first recording material 25 is not stopped at each of the detectors 8a, 8b, 8c, 8d, 8e, 8f (in a conveyance state) (a case with conveyance variation).

As shown in FIG. 5, by detecting the characteristic value of the first recording material 25 by each of the detection units 7a, 7b, 7c, 7d, 7e, 7f with the first recording material 25 being stopped at each of the detectors 8a, 8b, 8c, 8d, 8e, 8f, conveyance of the first recording material 25 causes no deviation (no deviation from a design reference value of 1.00). When the characteristic value of the second recording material 25 (the second recording material 25 and thereafter) is detected with reference to the characteristic value of the first recording material 25, all the characteristic values are within a determination threshold (±2%).

On the other hand, when the characteristic value is detected with the first recording material 25 being conveyed and a deviation occurs in conveyance of the first recording material 25, the detection result of the characteristic value of the first recording material 25 causes a deviation (a deviation from the design reference value of 1.00). When the characteristic value of the second recording material 25 (the second recording material 25 and thereafter) is detected with reference to the characteristic value of the first recording material 25 that includes the deviation (as the center of the determination threshold), a case occurs where even if the detection results of all the characteristic values are within ±2% with reference to the design reference value of 1.00, it is erroneously determined to deviate from the determination threshold (within ±2%). In this case, the measurement result of the characteristic value of the recording material 25 becomes incorrect, and the determination result by the controller 28 also becomes incorrect. As described above, the recording material determination device 1 according to this embodiment stops the first recording material 25 at each of the detectors 8a, 8b, 8c, 8d, 8e, 8f, and detects the characteristic value of the first recording material 25 in the stop state. Accordingly, the determination operation by the controller 28 is correctly performed.

As described above, the recording material determination device 1 in this embodiment stops the first recording material 25 at each of the detectors 8a, 8b, 8c, 8d, 8e, 8f, but causes the second recording material 25 to pass through each of the detectors 8a, 8b, 8c, 8d, 8e, 8f in the conveyance state. Accordingly, this device can correctly determine coincidence or noncoincidence of the recording material 25 without causing reduction in productivity in image formation.

(Modification 1)

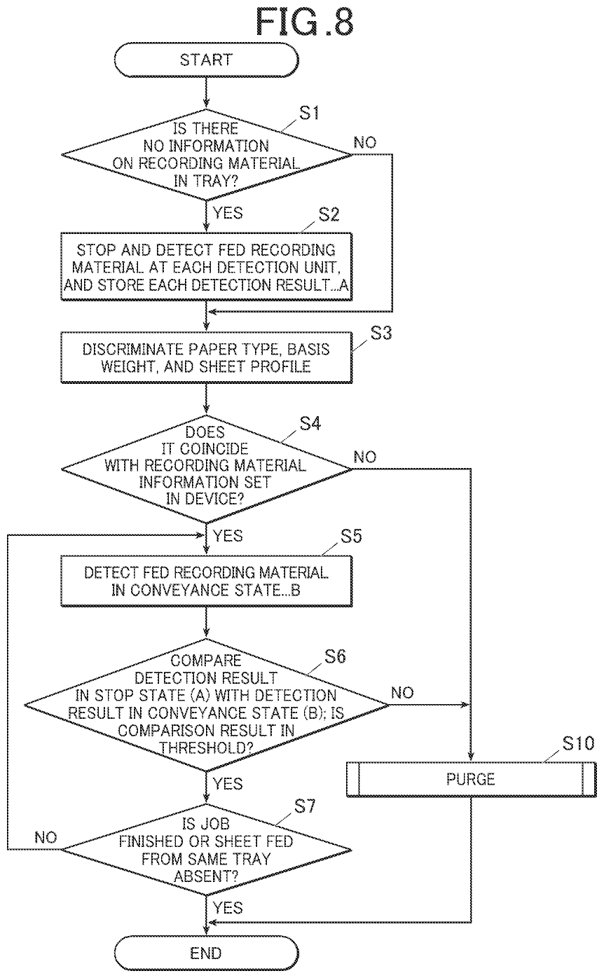

FIG. 8 is a flowchart showing Modification 1 of the recording material determination device 1 according to the first embodiment. Steps S1 to S7 of the flowchart according to this Modification are similar to those of the flowchart shown in FIG. 4. Accordingly, redundant description is omitted, and differences from the flowchart shown in FIG. 4 are described in detail.

As shown in FIGS. 3 and 8, in the recording material determination device 1, if it is determined that the first characteristics detection result and second characteristics detection result do not coincide with each other by the controller 28 (step S6), a conveyance path switching flap (purger) 35 shown in FIG. 1 is operated by the controller 28, the second recording material 25 is guided from the normal conveyance path 5 to a purging conveyance path 36 by the conveyance path switching flap 35, and the second recording material 25 is ejected (purged) to the sheet ejection tray (purge tray) 15 (step S10). Note that in this Modification, according to the recording material determination device 1, if the controller 28 determines that the first characteristics detection result and the second characteristics detection result do not coincide with each other (step S6), formation of the toner image on the intermediate transfer belt 11 by the image former 10 is stopped by the controller 28, and the toner image is prevented from being transferred onto the second recording material 25, thus allowing reuse of the second recording material 25 ejected to the purging sheet ejection tray 15.

As shown in FIG. 3, when purging the second recording material 25, the controller 28 of the recording material determination device 1 in this Modification may display the noncoincidence between the first recording material 25 (transfer material) and the second recording material 25 (transfer material) on the display 22 of the operation receiver 23, and/or issue a notification through the speaker, not shown, as described in the first embodiment.

The recording material determination device 1 according to this Modification as described above can exert advantageous effects similar to those of the recording material determination device 1 according to the first embodiment.

(Modification 2)

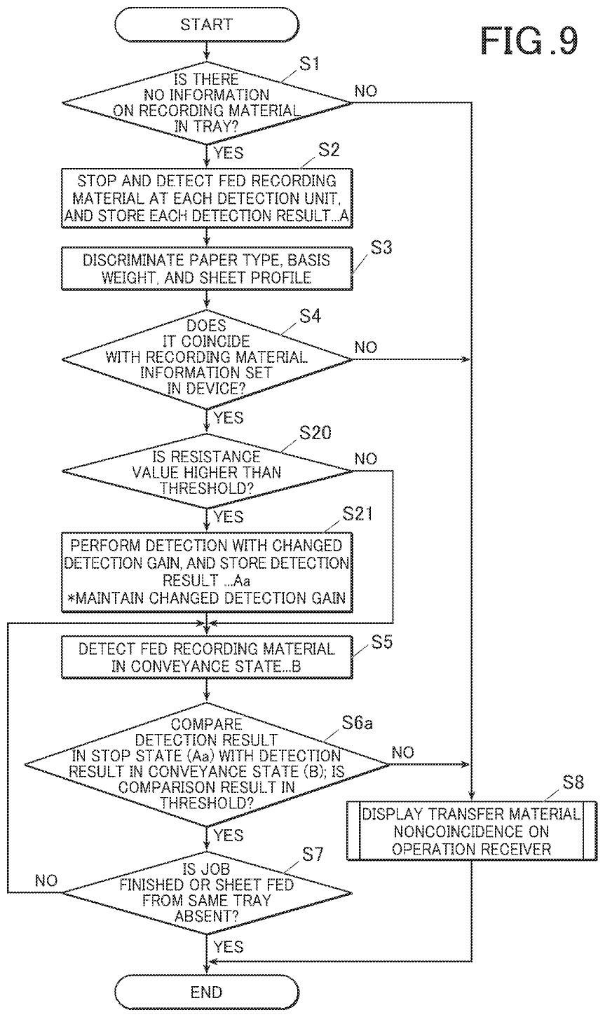

FIG. 9 is a flowchart showing Modification 2 of the recording material determination device 1 according to the first embodiment. Steps S1 to S4 and S7 to S8 of the flowchart according to this Modification are similar to those of the flowchart shown in FIG. 4. Accordingly, redundant description is omitted, and differences from the flowchart shown in FIG. 4 are described in detail.

As shown in FIG. 9, if the controller 28 of the recording material determination device 1 determines that the information on the recording material set in the RAM 28B or the storage 31 (the sheet information registered in the RAM 28B or the storage 31) coincides with the result of the type discrimination (step S4) and determines that the detection result of the resistance value of the first recording material 25 is equal to or more than the threshold (step S20), the controller 28 changes the gain of a gain changing circuit 33 (e.g., an operational amplifier) of the detection unit that detects the moisture rate (increases the gain), detects the moisture rate of the first recording material 25 with the changed gain, and stores the characteristic value (moisture rate) of the first recording material 25 as the first characteristics detection result in the RAM 28B or the storage 31 in a readable manner (step S21). The controller 28 causes the detection unit in the state of maintaining the changed gain to detect the characteristic value (moisture rate) of the second recording material 25, and stores the detection result as the second characteristics detection result in the RAM 28B or the storage 31 in a readable manner (step S5).

As shown in FIG. 9, the controller 28 compares the first characteristics detection result with the second characteristics detection result, and determines whether the difference between both the results is within the determination threshold or not (step S6). Note that in FIG. 9, a result (Aa) of detection of the first recording material 25 by each of the detectors 8a, 8b, 8c, 8d, 8e, 8f in the stop state is the first characteristics detection result, and a result (B) of detection of the second recording material 25 by each of the detectors 8a, 8b, 8c, 8d, 8e, 8f in the conveyance state is the second characteristics detection result. The first characteristics detection result and the second characteristics detection result compared by a recording material determiner 34 pertain to the moisture rate, the basis weight, and the paper thickness.

Such a recording material determination device 1 according to this Modification can exert advantageous effects similar to those of the recording material determination device 1 according to the first embodiment.

According to the recording material determination device 1 according to this Modification, the gain changing circuit 33 of the detection unit that detects the moisture rate of the recording material 25 changes the gain of the gain changing circuit 33 if the resistance value of the first recording material 25 is higher than the threshold, thereby allowing accurate detection of the moisture rate.

### SECOND EMBODIMENT

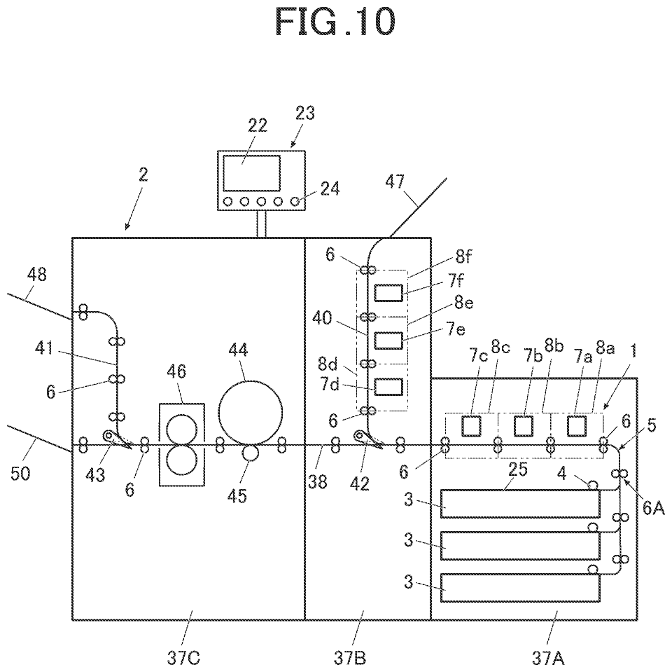

FIG. 10 is a configuration diagram of an image forming apparatus 2 that includes a recording material determination device 1 according to a second embodiment of the present invention.

As shown in FIG. 10, according to the image forming apparatus 2, which includes three units (37A, 37B and 37C) from a first unit 37A to a third unit 37C, sheet-shaped recording materials 25 stacked on each sheet feeder tray (sheet feeder) 3 are sent one by one to a conveyance path 5 by a sheet feeder roller 4. The recording material sent to the conveyance path 5 by a conveyor 6A that includes a plurality of conveyance roller pairs 6 is conveyed along the conveyance path 5. The conveyance path 5 includes: a horizontal-direction conveyance path 38 that horizontally extends from the first unit 37A to the third unit 37C; a first vertical-direction conveyance path (first purge conveyance path) 40 that branches from the horizontal-direction conveyance path 38 in the second unit 37B and extends in an upward direction; and a second vertical-direction conveyance path (second purge conveyance path) 41 that branches from the horizontal-direction conveyance path 38 in the third unit 37C and extends in the upward direction.

On the horizontal-direction conveyance path 38 in the first unit 37A, detectors 8a, 8b, 8c and detection units 7a, 7b, 7c that detect the moisture rates, basis weights and paper thicknesses of first and second recording materials are arranged in the horizontal direction.

On the first vertical-direction conveyance path 40 in the second unit 37B, detectors 8d, 8e, 8f and detection units 7d, 7e, 7f that detect the surface property, rigidity and resistance of the first recording material 25 are arranged in the vertical direction. In the second unit 37B, the horizontal-direction conveyance path 38 and the first vertical-direction conveyance path 40 allow the conveyance direction of the recording material 25 to be switched by a first conveyance path switching flap (first purger) 42 provided at the branching site of both the conveyance paths 38 and 40.

In the third unit 37C, the horizontal-direction conveyance path 38 and the second vertical-direction conveyance path 41 allow the conveyance direction of the recording material 25 to be switched by a second conveyance path switching flap (second purger) 43 provided at the branching site of both the conveyance paths 38 and 41.

In the third unit 37C, from the upstream side to the downstream side in the conveyance direction of the horizontal-direction conveyance path 38, an image former 44 that includes a photoconductive drum, a transfer roller 45, a fixer 46, and the second conveyance path switching flap 43 are sequentially arranged.

On an upper opening end side of the first vertical-direction conveyance path 40 of the second unit 37B, a first sheet ejection tray (first purge tray) 47 is provided. On an upper opening end side of the second vertical-direction conveyance path 41 of the third unit 37C, a second sheet ejection tray (second purge tray) 48 is provided. On an opening end side of the downstream of the recording material conveyance direction of the horizontal-direction conveyance path 38 of the third unit 37C, a third sheet ejection tray 50 is provided.

In such a recording material determination device 1, each characteristic value of the first recording material sent from the sheet feeder tray 3 to the conveyance path 5 is detected in the stop state at each of the detectors 8a, 8b, 8c on the horizontal-direction conveyance path 38 in the first unit 37A. This material is guided to the first vertical-direction conveyance path 40 by the first conveyance path switching flap 42. Subsequently, each characteristic value is detected in the stop state at each of the detectors 8d, 8e, 8f on the first vertical-direction conveyance path 40, and then this material is ejected to the first sheet ejection tray 47.

In the recording material determination device 1, the second recording material 25 sent from the sheet feeder tray 3 to the conveyance path 5 is not stopped at each of the detectors 8a, 8b, 8c on the horizontal-direction conveyance path 38 in the first unit 37A and is caused to pass. The characteristic values are detected by the detection units 7a, 7b, 7c of the detectors 8a, 8b, 8c.

Subsequently, as shown in FIG. 3, 4 or 8, in the recording material determination device 1 according to this embodiment, the first characteristics detection result and the second characteristics detection result are compared with each other by the controller 28, and if it is determined that the result of the comparison is not within the determination threshold (step S6), noncoincidence between the first recording material 25 (transfer material) and the second recording material 25 (transfer material) is displayed on the display 22 of the operation receiver 23, and/or a notification of the noncoincidence is issued through the speaker. The second recording material 25 is guided to the first vertical-direction conveyance path 40 by the first conveyance path switching flap 42, and is ejected to the first sheet ejection tray 47 (purged). Note that the second recording material 25 is not guided to the first vertical-direction conveyance path 40 by the first conveyance path switching flap 42, but is guided toward the horizontal-direction conveyance path 38 of the third unit 37C by the first conveyance path switching flap 42. No toner image is formed by the image former 44 and transfer roller 45, and this material is guided to the second vertical-direction conveyance path 41 by the second conveyance path switching flap 43, and may be ejected to the second sheet ejection tray 48 via the second vertical-direction conveyance path 41 (may be purged).

The recording material determination device 1 according to this embodiment as described above can exert advantageous effects similar to those of the recording material determination device 1 according to the first embodiment.

(Other Modifications)

The controller 28 may set the threshold for determining whether the first recording material 25 and the second recording material 25 change or not smaller as the paper thickness of the first recording material 25 is larger.

The controller 28 may correct the threshold for determining whether the first recording material 25 and the second recording material 25 change or not, based on the second characteristics detection result.

In the first and second embodiments, application of the recording material determination device 1 to the image forming apparatus 2 whose printing system is an electrophotographic system is described as examples. However, there is no limitation to this. Application can also be made to inkjet system image forming apparatuses, and other printing system image forming apparatuses.

Although embodiments of the present invention have been described and illustrated in detail, the disclosed embodiments are made for purposes of illustration and example only and not limitation. The scope of the present invention should be interpreted by terms of the appended claims.

1. A recording material determination device, comprising:
a conveyor that conveys recording materials along a conveyance path;
a detector that is provided at a middle of the conveyance path, and detects a characteristic value of each of the recording materials in conveyance; and
a hardware processor that controls driving of the conveyor, stops a first recording material among the recording materials at the detector, and does not stop a second recording material that is conveyed after the first recording material,
wherein the hardware processor determines whether the second recording material changes with respect to the first recording material, based on a first characteristics detection result of the first recording material detected by the detector, and on a second characteristics detection result of the second recording material detected by the detector.

2. The recording material determination device according to claim 1, wherein the hardware processor determines whether the second recording material changes with respect to the first recording material, according to whether the second characteristics detection result is in a predetermined threshold based on the first characteristics detection result.

3. The recording material determination device according to claim 1, wherein the hardware processor causes the detector to detect, as the characteristic value, at least one of a basis weight, a paper thickness, and a moisture rate of the recording material.

4. The recording material determination device according to claim 1, wherein the hardware processor discriminates whether the first recording material is a set recording material or not using the first characteristics detection result.

5. The recording material determination device according to claim 4, wherein the hardware processor causes the detector to detect, as the characteristic value, at least any one of a surface property, a rigidity, and a resistance value of the recording material, and performs the discrimination based on at least any one of the surface property, the rigidity and the resistance value.

6. The recording material determination device according to claim 4, wherein the hardware processor performs discrimination in at least any one of a type, a basis weight and a sheet profile between the first recording material and the set recording material.

7. The recording material determination device according to claim 1, wherein upon determination that the second recording material changes with respect to the first recording material, the hardware processor causes a display to display the determination result.

8. The recording material determination device according to claim 1, wherein upon determination that the second recording material changes with respect to the first recording material, the hardware processor causes the conveyor to convey the second recording material to a purge tray.

9. The recording material determination device according to claim 4, wherein upon discrimination that the first recording material is not the set recording material, the hardware processor causes a display to display the discrimination result.

10. The recording material determination device according to claim 3,
wherein the detector includes a gain changing circuit, and
the hardware processor changes a gain of the gain changing circuit, based on the first characteristics detection result.

11. The recording material determination device according to claim 10, wherein the hardware processor causes the detector to detect a resistance value of the first recording material, and when the resistance value in the first characteristics detection result is equal to or more than a threshold, the hardware processor increases the gain of the gain changing circuit.

12. The recording material determination device according to claim 2, wherein the larger a thickness of the first recording material is, the smaller the predetermined threshold is set by the hardware processor, the predetermined threshold being for determining whether the first recording material and the second recording material change or not.

13. The recording material determination device according to claim 2, wherein the hardware processor corrects the predetermined threshold, based on the second characteristics detection result.

14. A recording material determination method, comprising:
conveying recording materials along a conveyance path;
detecting a characteristic value of each of the recording materials in conveyance, by a detector provided at a middle of the conveyance path; and
controlling driving of the conveyor, stopping a first recording material among the recording materials at the detector, and not stopping a second recording material that is conveyed after the first recording material,
wherein the controlling determines whether the second recording material changes with respect to the first recording material, based on a first characteristics detection result of the first recording material detected by the detector, and on a second characteristics detection result of the second recording material detected by the detector.

15. A non-transitory computer readable storage medium storing a program causing a computer to perform the recording material determination method according to claim 14.

16. An image forming apparatus, comprising:
the recording material determination device according to claim 1; and
an image former that forms an image on the recording material.
